(19) United States
(12) Patent Application Publication
(10) Pub. No.: US 2007/0256569 A1
(43) Pub. Date: Nov. 8, 2007

(54) Tea vessel structure for straining out tealeaves

(76) Inventor: Tae-Hwan Lee, Gwancheon City (KR)

Correspondence Address: KED & ASSOCIATES, LLP, P.O. Box 221200, Chantilly, VA, 20153-1200, US

(21) Appl. No.: 11/797,186

(22) Filed: May 1, 2007

(30) Foreign Application Priority Data
May 2, 2006 (KR) 10-2006-0036984
May 30, 2006 (KR) 10-2006-0048617

(51) Int. Cl. A23L 1/00

(52) U.S. Cl. 99/275

(57) ABSTRACT

A vessel structure for straining out various tea leaves comprises a cup type of vessel including disposal cups or various forms of vessels comprises a lid put thereon and a loader integrally or detachably mounted in the vessel to receive tealeaves thereinto and strain them with water, in which the loader comprises a tea strainer including a tea straining wall that forms a plurality of holes around the circumference wall thereof to strain tealeaves and a bottom surface that forms a plurality of holes on a predetermined area adjacent the center portion thereof in order to function as a filter for straining the tealeaves; a cover including a supporting rod projected in a predetermined distance from and formed at the center thereof to support the tea strainer cooperating with the vessel lid and/or a second extending portion extended from the upper opening circumference of the tea strainer to be closely mounted to a vessel wall; and a base portion including a plurality of projecting portions projected from around the circumference of the lower portion of the tea strainer and/or a first extending portion integrally extended from around the circular circumference of the lower portion to be closely mounted to the wall portion of the vessel. Therefore, the invention comprises a vessel structure for straining out the tealeaves including a loader integrally and/or detachably mounted therein, in which the loader is separately adaptable to a disposable cup or all kind forms of vessel in order to strain the tealeaves for instant drinking.

### BACKGROUND OF THE INVENTION

The invention is related to a tea straining, and in particular, to providing a tea vessel structure for straining out various tealeaves with water, which comprises a loader integrally or detachably mounted in a vessel including a disposal cup or all kind forms of cup to receive tealeaves thereinto.

Herein, it is clear that the loader must be understood as one element of a teacup structure integrally or detachably constructed to strain out certain tealeaves as well as to enable the tea drink with the tealeaves being loaded therein.

A genial tea straining including a green tea, etc. is performed in a manner to mount a strainer in a teacup, load certain tealeaves in the strainer and pour hot water from over the certain tealeaves.

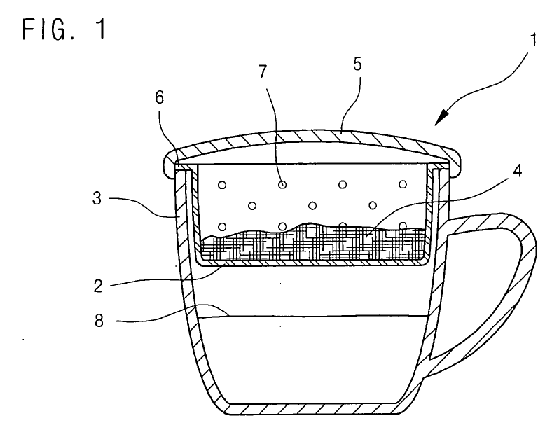

As shown in FIG. 1, a teacup for straining certain hub tealeaves such as a green tea is illustrated. The teacup 1 basically includes a vessel 3, a lid 5 and a tea strainer 2 positioned between the vessel 3 and the lid 5 with a flange 6 being formed on the circumference of an upper portion thereof. The tea strainer 2 is mounted on the upper portion of the vessel 3 with the flange 6 being put on the wall portion of the vessel 3, a shape of which is taken as a form of another vessel having a smaller diameter and volume. A plurality of tea straining holes 7 are formed in a predetermined arrangement on the circular wall and bottom surface of the tea strainer 2.

Therefore, when the teacup 1 is used, the tea strainer 2 is positioned on the vessel 3. A predetermined amount of tealeaves is loaded in the tea strainer 2 and then hot water is poured from over the tealeaves to be first strained out by an appropriate height of the vessel 3. Thereafter, the lid 5 is covered on the vessel 3, and the tealeaves are on standby for a certain time period to be secondly strained, thereby enabling a person to enjoy some tea.

But, such like a traditional mode for straining out tealeaves 4, directly, using the teacup 1, has structural disadvantages in that it is difficult for application. This application must include an exclusive cup. Also, a general cup or vessel is not provided with a strainer. The strainer 2 has a limit to the depth over the vessel 3 with an amount of tealeaves being loaded therein. The depth has a problem in the use of the strainer 2 that enough could not strain the tealeaves because of a little pouring tea water 8.

In another example, there is a tea bag wrapping tealeaves in a closed bag form widely used because of its convenience that the tea bag is simply put in a disposal teacup or the other cup to strain the tealeaves loaded therein, directly. However, if a tea bag product made of a filter paper is used to put in tealeaves, it can't strain the tealeaves in the teacup, because most of commercial filter papers have a lower tea straining performance. It becomes cut in half the inherent taste of tea.

Furthermore, a teacup structure including a general strainer mounted therein forces tealeaves and water to be contacted with each other for a longer time period for obtaining tea fully strained to the extent that a user can drink in the process of pouring hot or cool water into the strainer. It has a disadvantage in that the teacup structure is often used to transferring its inherent taste of tea such as a green tea, a jasmine tea, etc. to a drinker. As a result, it causes the lowering of the inherent tea taste.

Due to these and those problems, it is preferable if a tea strainer is separately or integrally mounted in a teacup, a disposal cup or a vessel, etc. to strain out the contents of tealeaves to the extent that certain tealeaves can be kept in the original inherent taste thereof without being damaged.

Also, it is preferable if a tea strainer has a structure mounted in a teacup to minimize a bitter taste of tealeaves after being strained out.

A main object of the invention is to provide a tea vessel structure for straining out various tealeaves with water, which comprises a loader integrally or detachably mounted in a vessel including a disposal cup or all kind forms of cup to receive the tealeaves thereinto.

The other object of the invention is to provide a tea vessel structure for straining out a green tea and a jasmine tea of various tealeaves so that an inherent bitter taste thereof is not remained last after being strained, which comprises a loader integrally or detachably mounted in a vessel including a disposal cup or all kind forms of cup to receive tealeaves thereinto.

### SUMMARY OF THE INVENTION

In order to accomplish these objects of the invention, according to one embodiment of the invention, a tea vessel structure comprise a vessel of a disposal cup type or in all kind forms of cup including a lid; and a loader including a tea strainer positioned with an amount of tealeaves in the vessel, stably, with a tea-straining wall and a bottom surface forming a plurality of tea-straining holes in a predetermined arrangement and a cover removable mounted to open/close the upper opening of the tea strainer with a supporting rod being extended from the upper center portion thereof to the lower surface of the lid.

According to another embodiment of the invention, a tea vessel structure comprise a vessel of a disposal cup type or various forms of cup; a lid covering the upper portion of the vessel; and a loader containing a predetermined amount of tealeaves therein to strain out tealeaves by pouring water over tealeaves, in which the loader includes a tea strainer with a tea straining wall forming a plurality of tea-straining holes around the circumference thereof to function as a filter for straining tealeaves and a bottom surface forming a plurality of tea-straining holes adjacent to the center portion thereof in a predetermined arrangement and a cover removably mounted to cover the upper surface of the tea strainer with a supporting rod being integrally projected from the upper center portion thereof to cooperate with the lid, and a base portion projected from a bottom surface of the tea strainer to keep a predetermined gap between the lower surface of the vessel and the bottom surface of thereof.

According to another embodiment of the invention, a tea vessel structure comprise a vessel of a disposal cup type or various forms of cup; a lid covering the upper portion of the vessel; and a loader containing a predetermined amount of tealeaves therein to strain out the tealeaves by pouring water over the tealeaves and then permits tea strained to be withdrawn without being contacted with the tealeaves and integrally and detachably mounted therein, in which the loader includes a tea strainer with a tea straining wall forming a plurality of tea-straining holes around the circumference thereof to function as a filter for straining tealeaves and a bottom surface forming a plurality of tea-straining holes adjacent to the center portion thereof in a predetermined arrangement and a cover removably mounted to cover the upper surface of the tea strainer with a supporting rod being integrally projected from the upper center portion thereof to cooperate with the lid and a second extending portion extended from around the upper circumference of the tea-straining wall to be closely contacted to the wall portion of the vessel, a base portion projected from a bottom surface of the tea strainer to keep a predetermined gap between the lower surface of the vessel and the bottom surface of thereof and a first extending portion integrally extended from around the lower circumference of the tea-straining wall to be closely contacted to the vessel wall.

According to another embodiment of the invention, a tea vessel structure comprise a vessel of a disposal cup type or various forms of cup; a lid covering the upper portion of the vessel; and a loader containing a predetermined amount of tealeaves therein to strain out the tealeaves by pouring hot water over the tealeaves, in which the loader comprises a tea strainer, the tea strainer including a tea straining wall provided with a retaining wall having a certain depth to receive an amount of tealeaves and forming a plurality of tea-straining holes around the circumference thereof over the retaining wall to enable the straining of the tealeaves and a lower wall including a lower surface that forms a plurality of tea-straining holes in a predetermined area adjacent to the center portion thereof; a first extending portion integrally extended from around the lower circumference of the bottom surface to be closely contacted to the vessel wall and including a plurality of holes formed adjacent to the vessel wall for withdrawing some tea strained and at least one fixing portion extended from predetermined portions around the circumference of the first extending portion to be closely supported to the vessel wall; and a cover including an upper surface forming a plurality of holes to inflow water onto the tealeaves loaded therethrough, a flange extended downward from around the outer circumference of the upper surface to be closely contacted to the upper portion of the tea-straining wall, a second extending portion extended passing the flange from the upper surface with a plurality of second holes formed adjacent to the vessel wall to withdraw some tea strained and at least one second fixing portion extended from predetermined portions around the circumference of the second extending portion to be closely supported to the vessel wall.

According to another embodiment of the invention, a tea vessel structure comprise a loader that is formed as a tea strainer of a basket shape having a wall portion extended facing to an arc portion of a vessel wall from the middle height portion to the upper portion of the vessel wall.

According to another embodiment of the invention, a tea vessel structure comprise a loader including a tea strainer of a basket shape having a wall portion extended facing to an arc portion of a vessel wall from the middle height portion to the upper portion of the vessel wall and flanges expended from the upper and/or lower portions of the tea strainer to position the tea strainer adjacent to the vessel wall.

According to the other embodiment of the invention, a tea vessel structure comprise a vessel of a disposal cup type or various forms of cup; a lid covering the upper portion of the vessel; and a loader containing a predetermined amount of tealeaves therein to strain out the tealeaves by pouring hot water over the tealeaves, in which the loader comprises a cap portion supported on the lid and including cutting portion formed at the center to supply tea water into the loader and a coupling groove portion formed on the lower extending portion thereof; and a tea strainer including a cylindrical body provided with a coupling projection formed around the circumference adjacent to the upper portion thereof to be coupled into the groove portion, a lower surface forming a plurality of tea-straining holes in a predetermined area adjacent to the center portion thereof and a tea straining wall provided with a retaining wall having a certain depth to receive an amount of tealeaves and forming a plurality of tea-straining holes around the circumference thereof over the retaining wall to enable the straining of the tealeaves.

### BRIEF DESCRIPTION OF THE INVENTION

The invention will be described in detail with reference to the attached drawings, in which;

FIG. 1 is a longitudinal cross-section view showing a conventional teacup that a strainer is provided on to strain out tealeaves;

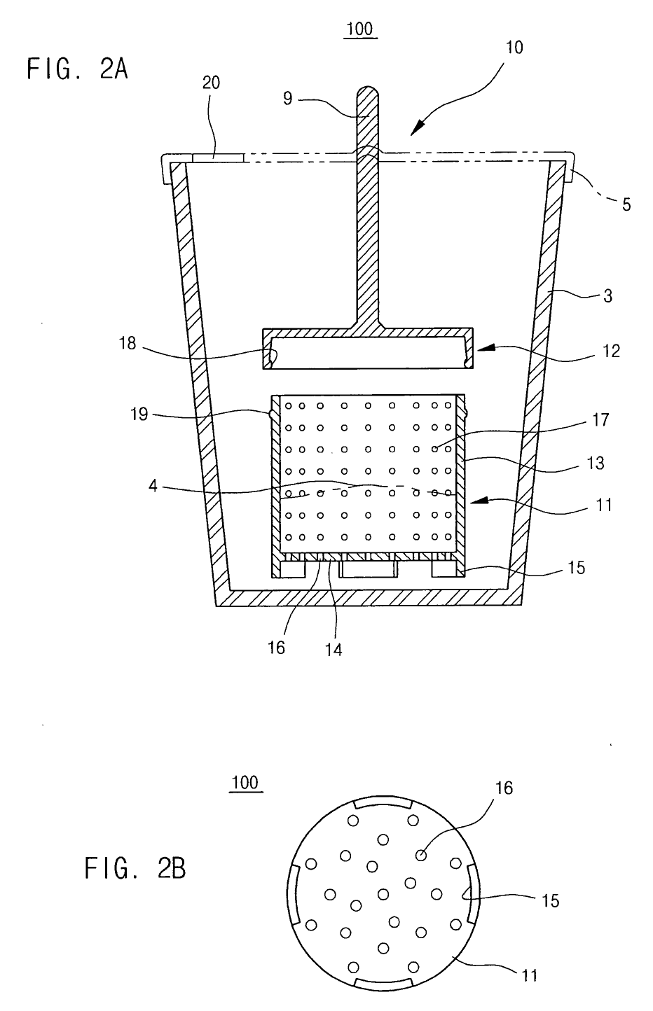

FIGS. 2A and 2B each is a longitudinal cross-section view and a lower view illustrating a tea vessel structure integrally provided with a loader for straining out tea leaves according to a first embodiment of the invention;

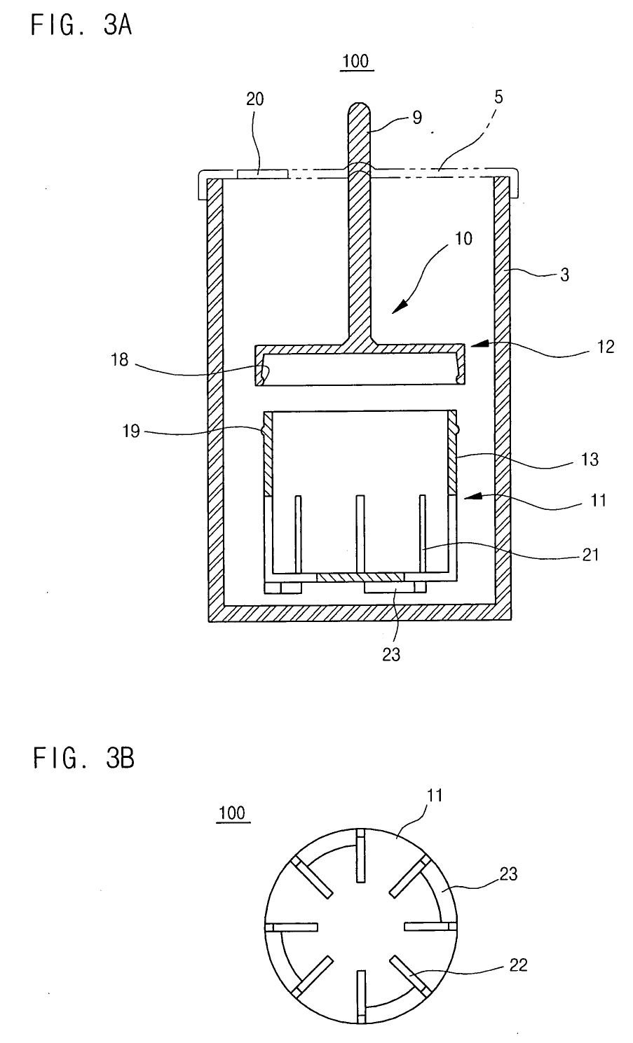

FIGS. 3A and 3B each is a longitudinal cross-section view and a lower view illustrating a tea vessel structure integrally provided with a loader, on the circumference of a wall portion of which a plurality of holes are formed in the form of a lengthy slot according to another varying example of the first embodiment;

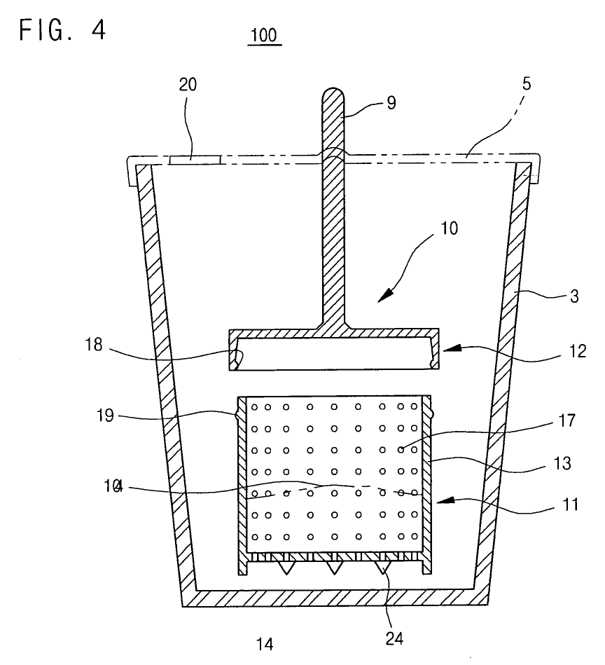

FIG. 4 is a longitudinal cross-section view illustrating a tea vessel structure integrally provided with a loader having a plurality of base projectors projected at a distance from each another from the circumference of its lower portion for straining out tealeaves according to another similar example of the first embodiment;

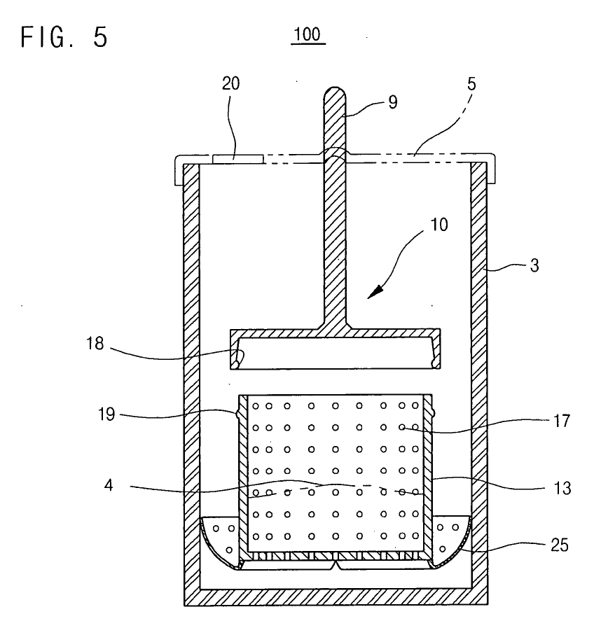

FIG. 5 is a longitudinal cross-section view illustrating a tea vessel structure integrally provided with a loader having a fixing or extending portion extended from the circumference of its base portion for straining out tealeaves according to another similar example of the first embodiment;

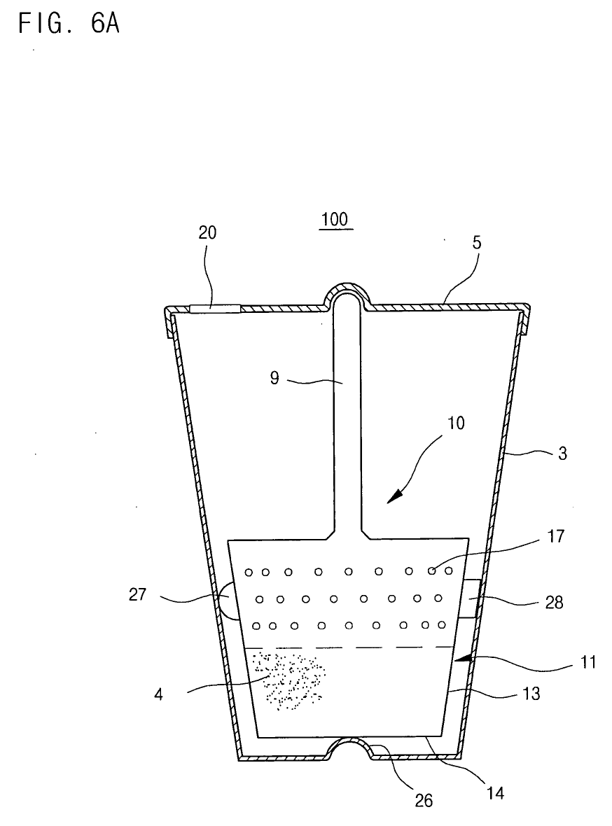

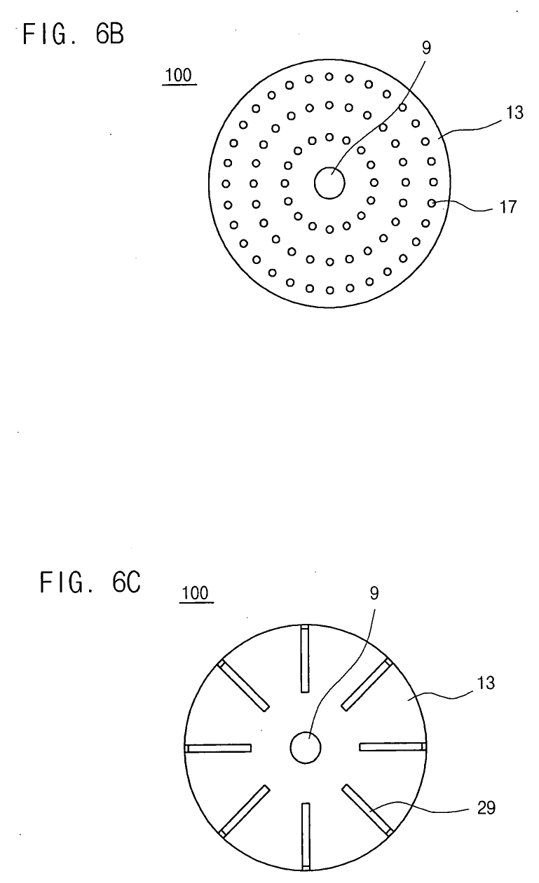

FIGS. 6A, 6B and 6C are a longitudinal cross-section view illustrating a tea vessel structure integrally provided with a loader for straining out tealeaves and bottom views illustrating a loader having a plurality of circular or slot shaped holes formed on its lower portion according to a second embodiment of the invention;

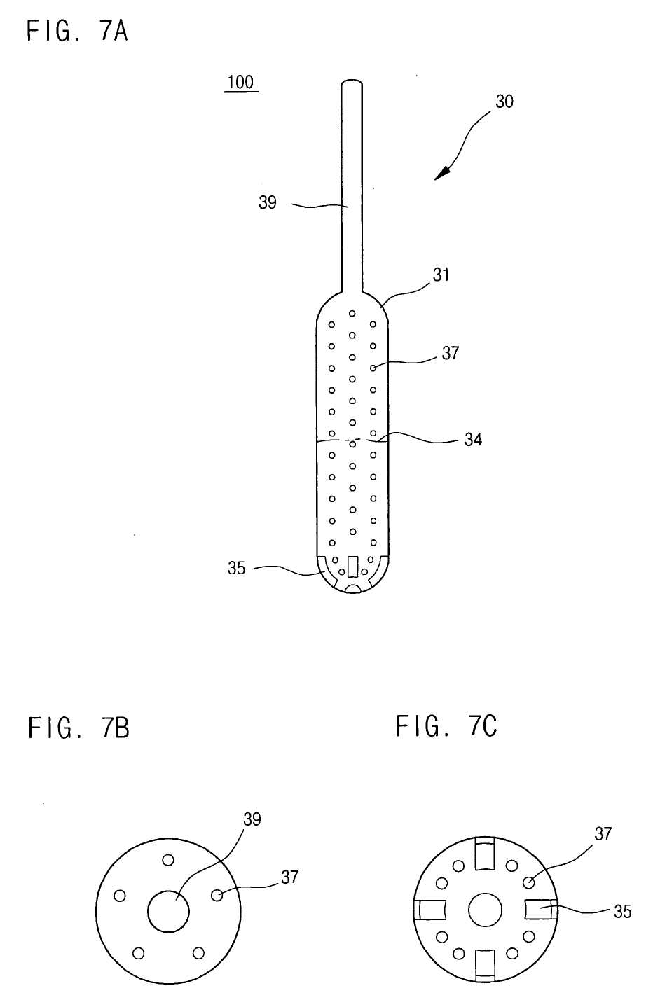

FIGS. 7A, 7B and 7C are a longitudinal cross-section view illustrating a tea vessel structure integrally provided with a loader for straining out tealeaves and bottom views illustrating a loader having a plurality of circular or slot shaped holes formed on its body or lower portions according to another varying example of the second embodiment;

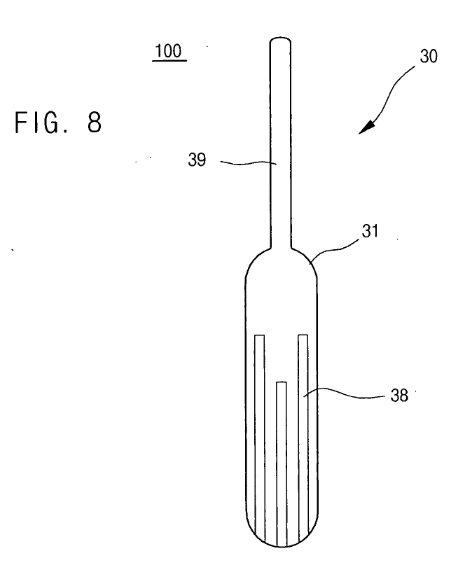

FIG. 8 is a longitudinal cross-section view illustrating a configuration of a loader integrally mounted in a tea vessel structure for straining out tealeaves according to another similar example of the second embodiment;

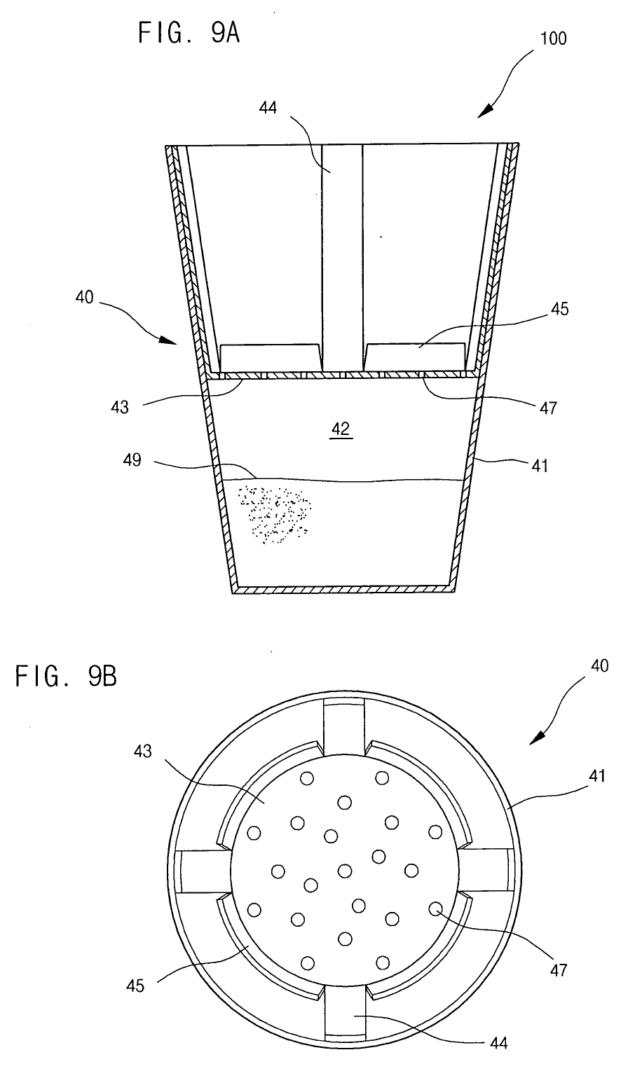

FIGS. 9A and 9B each is a longitudinal cross-section view and an upper view illustrating a tea vessel structure with a loader being integrally mounted therein to receive tealeaves according to a third embodiment;

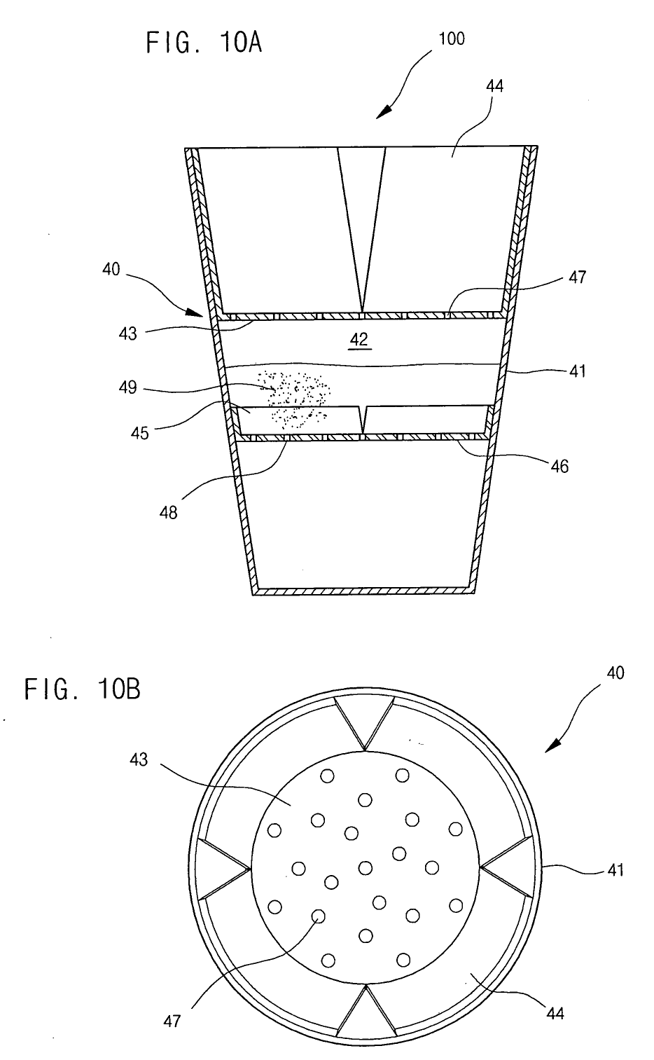

FIGS. 10A and 10B each is a longitudinal cross-section view and a lower view illustrating a tea vessel structure integrally provided with a loader being mounted therein to receive tealeaves according to another varying example of the third embodiment;

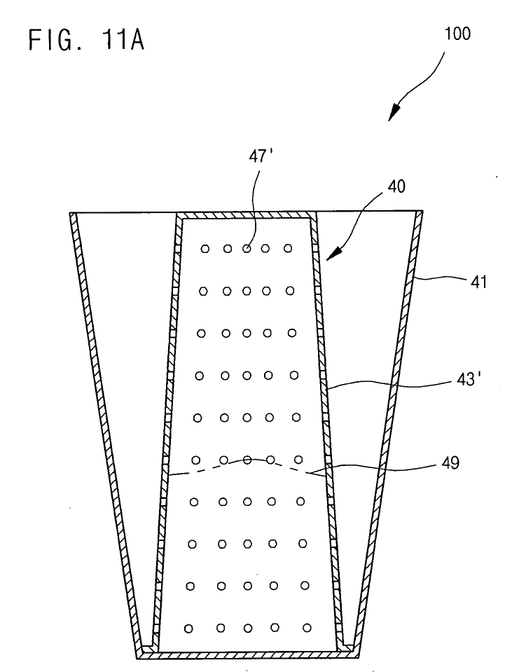

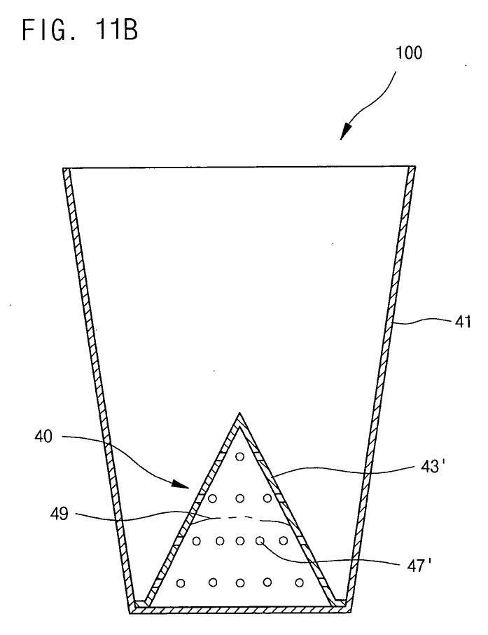

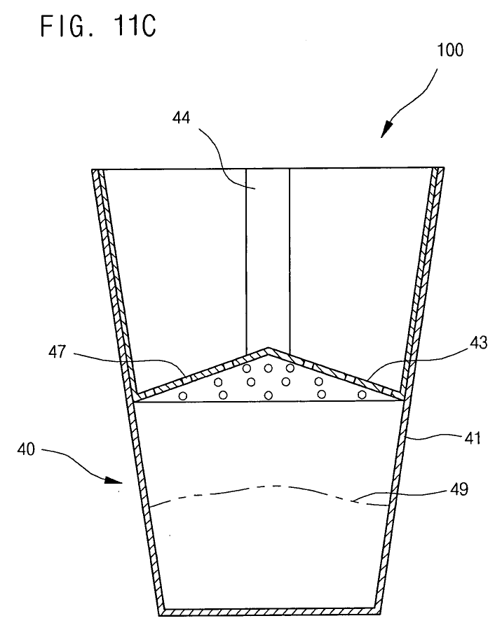

FIGS. 11A, 11B and 11C are a longitudinal cross-section illustrating a tea vessel structure integrally provided with a loader for straining out tealeaves according to another varying example of the third embodiment;

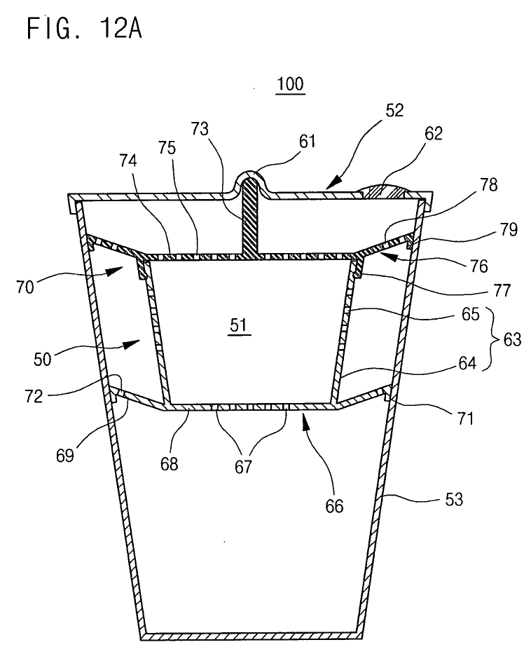

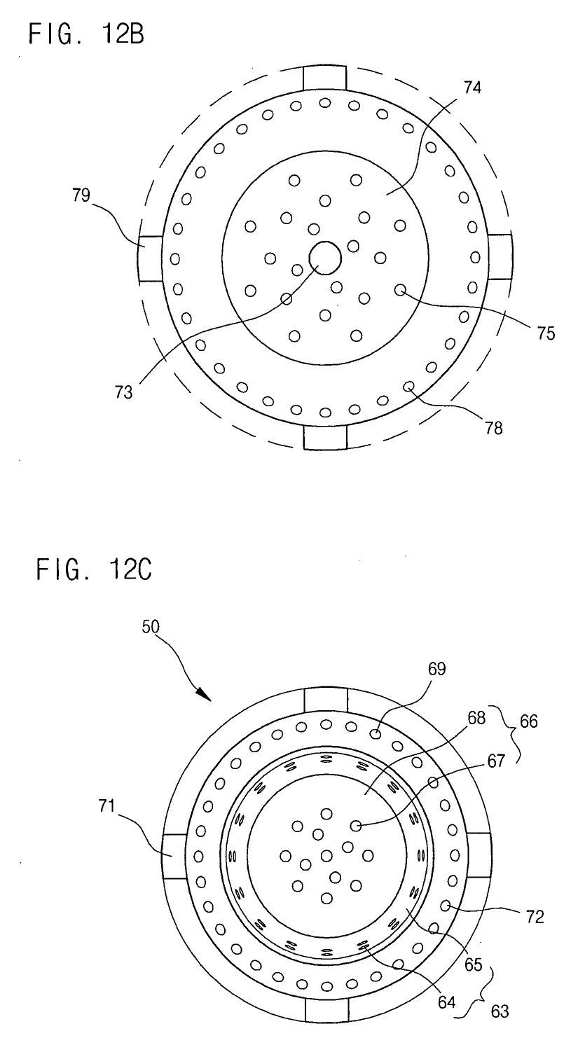

FIGS. 12A, 12B and 12C each are a longitudinal cross-section illustrating a tea vessel structure integrally provided with a loader for straining out tealeaves, a plan view illustrating an upper cover of the loader and an upper plan view of a lower vessel according to another varying example of the fourth embodiment;

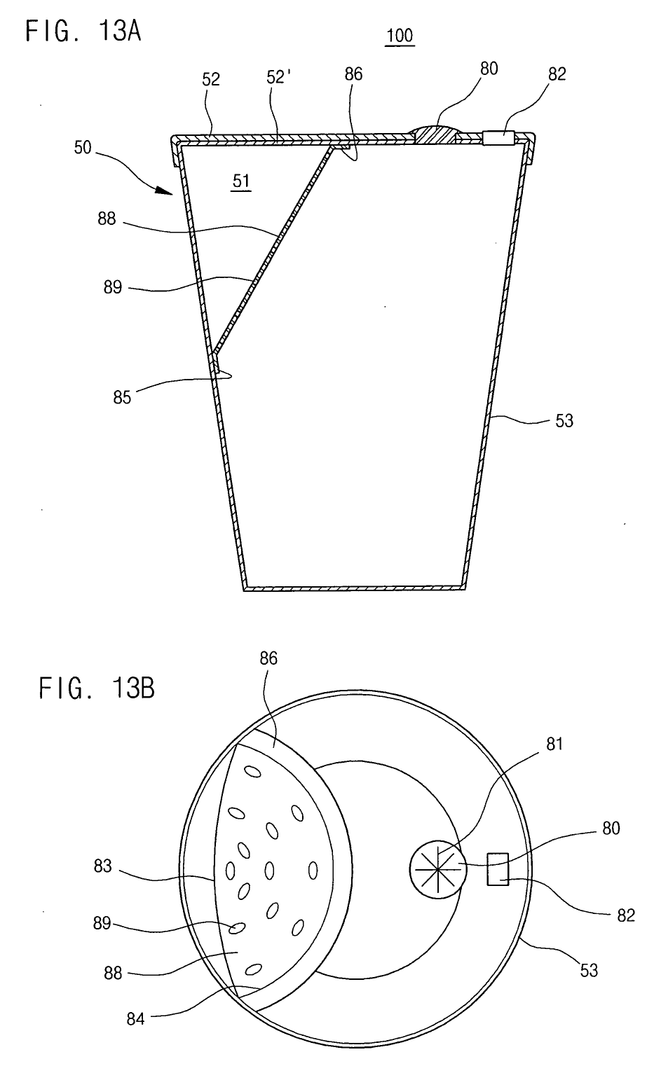

FIGS. 13A and 13B each is a longitudinal cross-section view illustrating a tea vessel structure integrally provided with a loader for straining tealeaves and an upper plan view seen from the upper portion of the load according to another varying example of the fourth embodiment;

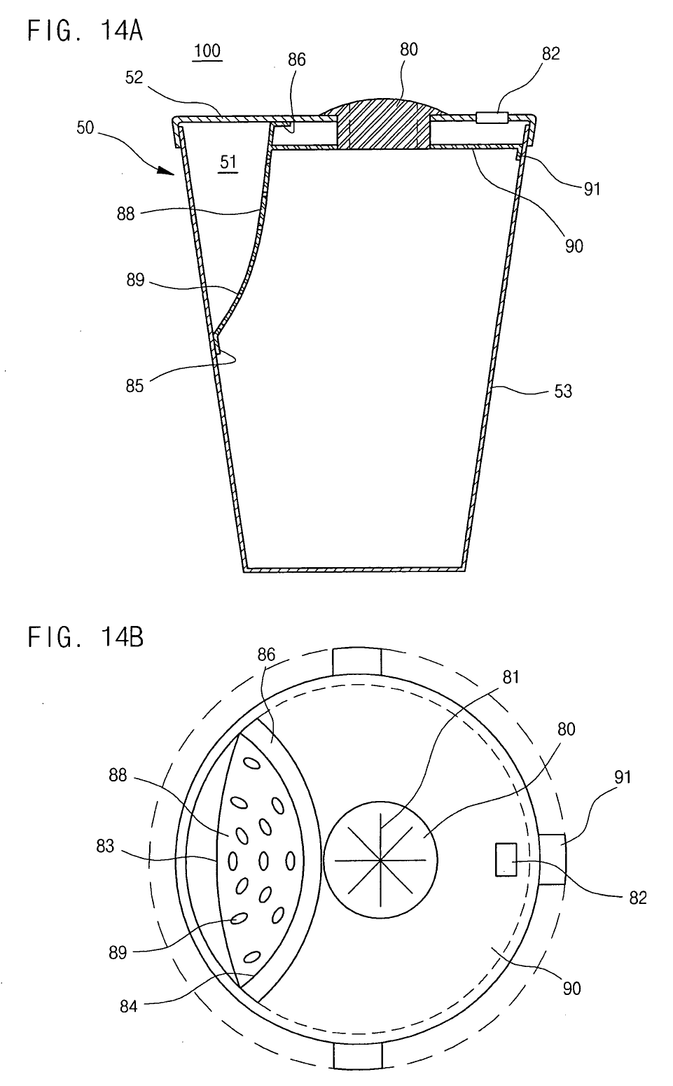

FIGS. 14A and 14B each is a longitudinal cross-section view illustrating a tea vessel structure integrally provided with a loader for straining tealeaves and an upper plan view seen from the upper portion of the load according to another varying example of the fourth embodiment; and,

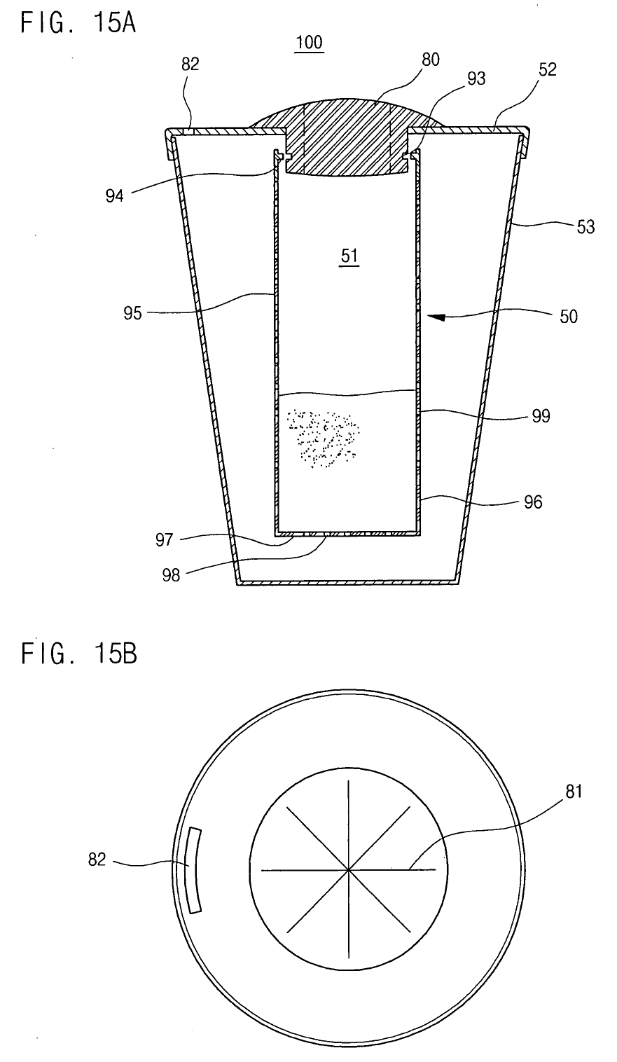

FIGS. 15A and 15B each is a longitudinal cross-section view illustrating a tea vessel structure integrally provided with a loader for straining tealeaves and an upper plan view seen from the upper portion of the load according to another varying example of the fourth embodiment.

### DETAILED DESCRIPTION OF THE INVENTION

According to a first embodiment of the invention, as shown in FIGS. 2A and 2B, a tea vessel 100 comprises a vessel 3 of a disposal cup type or in all kind forms of cups, a lid 5 closing the upper opening portion thereof; and a loader 10 retaining an amount of tealeaves therein to strain out tealeaves with water supplied thereinto. The loader 10 can be used to make various teas such as a puer tea, a jasmine tea, a green tea, an oolong tea, a black tea, a hub tea, etc.

The loader 10 includes a tea strainer receiving tealeaves therein and a cover coupled to the upper opening of the tea streamer 11. The tea strainer 11 includes a tea-straining wall 13 that forms a plurality of tea-straining holes around the circumference thereof to function as a filter for straining the tealeaves and a bottom surface 14 forming a plurality of tea-straining holes 16 in a predetermined area adjacent to the center portion thereof. The cover 12 is removably mounted to cover the upper surface of the tea strainer and includes a supporting rod 9 integrally projected from the upper center portion thereof to be positioned in the loader 10 cooperating with the vessel lid 5.

The tea strainer 11 can be made in the form of a cylindrical body to have a circular section and includes a plurality of tea-straining holes formed on the sidewall and bottom portion thereof to allow water in the vessel to be freely communicated therewith. The tea strainer 11 includes a leg portion 15 projected downward in a predetermined length from the button surface 14 to keep a predetermined gap between the bottom surface 14 and the bottom wall of the vessel 3, when it is positioned in the vessel 3.

The cover 12 includes a cylindrical body having a cross-section of a diameter little larger than that of the tea strainer 11 to be coupled therewith and detachably mounted to the tea strainer 11 in order to open/close the upper opening thereof. For it, a coupling portion 18 of a ring shape is projected from around the inner lower circumference of the cover 12, and a projection 19 is formed adjacent to the outer upper circumference of the tea strainer 11. A supporting rod 9 is projected from the upper center portion of the cover 12 to be coupled with the inner center portion of the lid 5, when the cover 9 is positioned in the tea vessel 3 with being coupled to the tea strainer 11. Herein, it is known that there may be another configuration of the coupling portion 18 and the projection 19 to couple the cover 12 with the tea strainer 11. For example, a plurality of grooves is formed on the inner lower circumference of the cover 12, and on the contrary, a plurality of projections is formed on the upper opening circumference of the tea strainer 11. The grooves and the projections are coupled with each another, thereby enabling the cover 12 to be fitted onto the sidewall of the tea strainer 11.

As described above, it is noted that the tea vessel structure 100 comprises the loader 10 and the vessel 3 having the lid 5. Therefore, in order to drink tea, a predetermined amount of tealeaves are first loaded in the tea strainer 11, and then the loader 10 with the cover 12 coupled to the tea strainer 11 is positioned at the nearly center portion of the vessel 3. Therefore, the tea vessel structure 100 is constructed as a perfect product, as the lid 5 is assembled to the upper opening portion of the vessel 3 to support the loader 11. Thereafter, a customer who commercially buys the tea vessel structure 100 pours an appropriate amount of hot or cool water thereinto, then covers the lid 5 over the upper opening portion thereof and can drink tea through a withdrawal hole 20.

From now, some embodiments will be illustrated for the purpose of helping the understanding of the invention, and same reference numbers are referred to same parts or elements, its detailed description of which will be omitted in order to avoid overlapping.

As shown in FIGS. 3A and 3B, according to another embodiment of the invention instead of tea-straining holes 17 and 16 each formed on a tea-straining wall 13 and a bottom surface 14 of a tea strainer, a plurality of vertical slots 21 are perforated in a longer hole form on the tea straining wall 13, and a plurality of horizontal slots 22 are radially formed at a predetermined angle spaced away from each another on a bottom surface 14. A base portion 23 is projected from the bottom outer surface of the tea strainer 11 to have in a predetermined height, thereby keeping a predetermined gap with the bottom wall of the vessel 3.

As shown in FIG. 4, a loader 10 of another embodiment similar to the first one is illustrated. A plurality of base prohections 24 is formed in a predetermined arrangement on the bottom outer surface of the loader 11, which is similar to the base portion 23.

As shown in FIG. 5, a loader 10 of another embodiment similar to the first one is illustrated. Instead of a leg portion 15, an extending portion 25 is configured as another element for supporting a tea strainer 11 on a loader 10 to be extended in a predetermined distance from the lower portion of a tea-straining wall 13 and have a predetermined width, so that it is arranged adjacent to the inner wall of a vessel 3 at the time of being enlarged. For example, the extending portion 25 is enlarged in a direction out of the lower portion of the tea-straining wall 13 to be bent with some elasticity. Therefore, the extending portion 25 is supported at a floating state in the vessel 3 with being closely contacted to the inner wall of the vessel 3, a plurality of another tea-straining holes is formed on the area portion of the extending portion 25 to allow a user to drink tea.

As shown in FIGS. 6A, 6B and 6C according to another embodiment varied from the first embodiment of the first embodiment of the invention, this embodiment suggests another method of positioning a loader 10 in a vessel 3. Herein, it is understood that the configuration of mounting a tea strainer 11 and a cover 12 with a supporting rod 9 formed at the center in the loader 10 is not clearly illustrated, but it is similar to those of the first embodiment as depicted in FIG. 2. The loader 10 is positioned in another method unlike that of using base portions 15 and 23, a base projection 24 and an extending portion 25.

The loader 10 is positioned on a spacer 26 projected from the bottom wall of a vessel 3, which keep a certain gap with the center of a bottom surface 14 of the loader 10 supported thereby. A plurality of adjacent projections are formed in a circular or square shape adjacent to the upper portion around the outer circumference of the loader 10 in a manner to be fixed thereon or projected therefrom. Therefore, when the loader 10 is positioned in the vessel 3, the adjacent projections 27 and 28 is contacted to the inner wall of the vessel 3 to be supported spaced away in a gap therefrom, thereby enabling a smooth tea-straining of tealeaves.

Also, as shown in FIG. 6B, a plurality of tea-straining holes 16 are formed on the upper surface of the loader. As shown in FIG. 6C, a plurality of slots 29 can be radially formed in a certain distance from each another on the upper surface of the loader 10.

As shown in FIGS. 7A, 7B and 7C according to a second embodiment of the invention, a loader 30 constructed as a single body is suggested.

The loader 30 comprises a tea strainer 31 of a cylinder type containing tealeaves that is integrated with a supporting rod 39, which is made of sanitary copolymer materials. In that case, the loading of tealeaves 34 is made in a tea strainer 31 before being molded, or a cutting portion formed at a certain place and size at the time of molding is sealed after the loading of the tealeaves in the loader 30. A plurality of tea-straining holes 37 is formed across a body of the tea strainer 31, and a plurality of slots 38 is radially formed in a certain distance from each another on a bottom surface of the loader 30.

As shown in FIG. 7B, the supporting rod 39 is extended upward from the upper center portion of the tea strainer 31, and a plurality of tea-straining holes 37 are formed on the upper surface of the tea strainer 31. The supporting rod 39 can be used as a handle or as an element for positioning the loader 30 in the vessel.

As shown in FIG. 7C, a flat base portion 35 is formed on the bottom surface of the tea strainer 31, and a plurality of tea-straining holes 37 are radially formed at a certain distance from each another on the inside circumference of the bottom surface of the tea strainer 31.

As shown in FIG. 8, according to another embodiment similar to the second embodiment of the invention, a tea strainer 31 includes a plurality of slots 38 instead of tea-straining holes 38 to strain out tealeaves. The slots 38 are radially arranged in a certain distance from each another around the circumference of a tea-straining wall of the tea strainer 31, and their cutting heights are different.

As shown in FIGS. 9A and 9B, according to a third embodiment of the invention, a tea vessel structure 100 comprises a vessel 3, the lower portion of which is constituted as a part of a loader 40 receiving tealeaves therein.

The loader 40 is supposed to functions as a tea strainer in itself, which comprises a cover 43. A plurality of tea-straining holes 47 is formed in a predetermined arrangement on the cover 43. A plurality of supporting pieces 44 is extended in a longer strip shape from a certain portion of the outer circumference to the upper portion of the cover 43, and a plurality of flaps 45 having a shorter height are arranged between the supporting pieces 44. As shown in 9B, the supporting pieces 44 are closely adhered in a predetermined width on the almost diameter lines of the cover 43 from a middle portion to an upper portion of the inner wall of the vessel 41. Therefore, the drawing illustrates that the tea vessel structure 100 is not provided with a lid, but in use tealeaves are first loaded in the tea strainer 42 with the lid being removed. Of course, the cover 43 is supported at a predetermined position with the supporting pieces 44 and the flaps 45 being closely contacted to the inner wall of the vessel 41.

As shown FIGS. 10A and 10B, according to another embodiment similar to the third embodiment of the invention, a tea vessel structure 100 comprises a loader 40 constructed as an independent partition chamber receiving tealeaves 49 on the middle portion of a vessel 41. The loader 40 includes a tea strainer 41, a bottom surface 46 of which is positioned at a predetermined height from the bottom wall of the vessel 3, and a cover 43 spaced away in a predetermined distance from the bottom surface 46 to form a certain space there between. A plurality of first tea-straining holes is formed in a predetermined arrangement across the area of the bottom surface 46 to strain out tealeaves as well as to withdraw tea from the vessel 3, a plurality of flanges or flaps 45 is extended at a certain distance from around the outer circumference of the bottom surface 45 to be closely adhered to the inner wall of the vessel 41. The flap 45 can be fixed at a predetermined position to the inner wall of the vessel 41 by means of another known fixing element.

The cover 43 includes a tea-straining portion that is constituted as a part thereof, on the area of which a plurality of tea-straining holes is perforated in a predetermined arrangement to strain out tealeaves, and a supporting portion 44 extended from around the circumference of the tea-straining portion to the almost upper portion of the vessel 41. The supporting portion 44 is closely adhered to the inner wall of the vessel 41 to support the cover 43 on the predetermined position of the vessel. If necessary, the fixing of the cover 3 can be done by using another fixing element.

In another manner, as shown in FIG. 10B, the supporting portion 44 is closely adhered onto the upper circumference of the vessel 41 so that the cover 43 is also supported in a predetermined position. Herein, it is noted that the diameters of the bottom surface 46 and the tea-straining portion of the cover 43 each is equal to the inner corresponding one of the vessel 41, so that the bottom surface 46 and the tea-straining portion is supported facing to the inner wall of the vessel 41 having diameters smaller than their ones.

As shown in FIG. 11A, according to another embodiment similar to the third embodiment of the invention, a tea vessel structure 100 comprises a loader 40 of a cup type for straining out tealeaves. The loader 40 is turned upside down to direct its opening toward the bottom wall, in which an amount of tealeaves are loaded. A plurality of tea-straining holes 47′ are formed in a predetermined arrangement on the circumferential portion of a tea-straining wall 43′ of the loader 40 in order to strain out tealeaves and withdraw tea strained therethrough.

As shown in FIG. 11B, according to another embodiment similar to the third embodiment of the invention, a tea vessel structure 100 comprises a loader 40 of a cone type for straining out tealeaves. The loader 40 is turned upside down to direct its opening toward the bottom wall, in which an amount of tealeaves are loaded. A plurality of tea-straining holes 47′ are formed in a predetermined arrangement on the circumferential portion of a tea-straining wall 43′ of the loader 40 in order to strain out tealeaves and withdraw tea strained therethrough.

As shown in FIG. 11C, according to another embodiment similar to the third embodiment of the invention, a tea vessel structure 100 comprises a loader 40, in which a lower portion of a vessel 41 is constituted as the loader 40 receiving an amount of tealeaves. The loader 40 comprises a cover 43. A plurality of tea-straining holes 47 is formed in a predetermined arrangement on the cover 43. A plurality of supporting pieces 44 is extended in a longer strip shape from a certain portion of the outer circumference to the upper portion of the cover 43 to be symmetrical to each another. The supporting pieces 44 are closely adhered in a predetermined width from a middle portion to an upper portion of the inner wall of the vessel 41 According to a fourth embodiment of the invention, as shown in FIGS. 12A, 12B and 12C, a tea vessel structure 100 is adaptable to disposal cups or all kind forms of cups.

The tea vessel structure 100 comprises a lid 52 covering the upper portion of a vessel 53 and a loader 50 including a tea strainer 51 containing a predetermined amount of tealeaves. Herein, a projecting portion 62 is formed on the lid 52 to support a cover 70 of the tea strainer 51, and a withdrawal hole 62 is formed adjacent to the circumferential portion of the lid 52 to allow a user to enjoy tea.

The loader 50 is constructed in the vessel 53 according to the principle of the invention. The loader 50 comprises the tea strainer 51 including a body 63 that receives an amount of tealeaves and a bottom surface 66 constituted as its lower surface. The body 63 includes a retaining wall 64 having a certain depth to receive an amount of water and a tea-straining wall 65 forming a plurality of tea-straining holes around the circumference thereof over the retaining wall to enable the straining of the tealeaves. The lower wall 66 includes a lower surface that forms a plurality of tea-straining holes 67 in a predetermined area adjacent to the center portion thereof, a first extending portion 69 integrally extended from around the lower circumference of the lower surface 68 and at least first fixing portion 71 extended from predetermined portions around the circumference of the first extending portion 69 to be closely supported to the vessel wall. A plurality of first tea-withdrawing holes 72 is formed on the first extending portion 69 adjacent to the inner wall of the vessel 53. The extending portion 69 is inclined upward by 30°˜40° to the horizontal plane of the lower surface 68, so that it enables tea strained to be withdrawn for drinking without being secondly contacted with the tealeaves in the loader 50.

The cover 70 includes an upper surface 74 and a second extending portion from around the outer circumference of the upper surface 74. The second extending portion 76 is inclined upward by 30°˜40° to the horizontal plane of the upper surface 74, so that it enables tea strained to be withdrawn for drinking without being secondly contacted with the tealeaves in the loader 50. A plurality of inflowing holes 75 is formed on the upper surface 74 to inflow water onto the tealeaves loaded in the tea strainer 51 therethrough, and a supporting rod 73 is projected in a predetermined height from the center of the upper surface 74 to be coupled with the inner groove or ceil surface of the lid 52. A flange 77 is extended from the circumference of the upper surface 74 adjacent to the upper portion of the tea-straining wall 63 to function as a lid of the loader 50. The flange 77 includes a projection formed on the lower end thereof to be coupled with a groove formed at portion corresponding to the tea-straining wall 65. This coupling can be performed in another manner, for example at least two projections are projected from on the circumference of the upper surface 74, and corresponding grooves are formed on the upper border of the tea-straining wall 65, thereby enabling the coupling of the projections and grooves with each other. The second extending portion 76 is extended passing over the flange 77 from the upper surface 75 at a predetermined angle, for example 30°˜40°. A plurality of second withdrawing holes 78 is formed on the second extending portion 76 adjacent to the inner wall of the vessel 53 to withdraw tea strained for drinking. A second fixing portion 79 having a predetermined width is extended downward in a distance from a plurality of predetermined portions, for example 4 in the drawings, on the circumference or the whole circumference of the second extending portion 76 along the inner wall of the vessel 53, thereby supporting the load 50

Herein, it is noted that the cover 70 allows tealeaves contained in the tea strainer 51 to be strained out through a plurality of inflowing holes 75 formed on the upper surface 74. The second extending portion 76 permits tea strained to be withdrawn through the second withdrawing holes 78 along the inner wall of the vessel 53 adjacent thereto. The second fixing portions 79 forces the loader 50 to be closely contacted to a predetermined position of the vessel inner wall.

Therefore, the tea vessel structure 100 permits the loader 50 containing tealeaves for drinking therein to be removably positioned at an appropriate position in the vessel 53. In such like assembling state, as water is supplied over the loader 50 to be strained, tea strained well can be withdrawn passing through the first and second withdrawing holes 72 and 76 in order without being contacted with the tealeaves.

On the other hand, it is noted that the first and second extending portions 69 and 76 can be mounted to the tea strainer 51 at the same time or solely. For example, the loader 50 is provided with the second extending portion 76 only to be positioned in the vessel 53 and can be supported at a predetermined height in the vessel 53 by means of by a leg portion not shown. In case that the second extending portion 76 is solely supported in the vessel 53, it has to have certain stiffness. Instead of the configuration in that the first and second fixing portions 71 and 79 are extended downward from a plurality of predetermined portions on the circumference or the whole circumference of their extending portions, any one of them is extended upward closely contacting with the inner wall of the vessel 53 to determine the position of the loader 50 in the vessel 53 as well as to support the loader therein, separately.

As shown in FIGS. 13A and 13B, according to another varied embodiment similar to the fourth embodiment of the invention, a tea vessel structure 100 comprises a loader 50 that a tea strainer 51 is mounted on an arc portion of the inner wall of the vessel 53.

The tea vessel structure 100 comprise a lid 52 and the loader 52, in which the loader 50 includes a tea strainer 51 and a closing film member 52′ covering the opening of the vessel 53 directly below the lid 52. The closing film member 52′ functions as a supplementary means of the lid 52 and includes a plurality of holes formed thereon to permit water to be introduced into the tea strainer 51. The closing film member 52′ is coupled with the upper portion of the tea strainer 51, while it can be omitted.

The lid 52 comprises a withdrawing hole 82 and a plug 80 which are formed to withdraw tea strained. The plug 80 is made of vinyl or polycarbonate materials, on a plurality of diameter lines of the upper surface of which cutting or scoring lines 82 are formed from portions adjacent to the outer circumference to the center of the plug 80. The plug 80 is generally kept in a closed state, while cutting off the scoring lines 82, when needed can easily open it.

The tea strainer 51 includes a tea-straining wall 88 extended facing to an arc portion of a vessel wall from the middle height portion to the upper portion of the vessel wall. A lower edge 83 of the tea-straining wall 88 is formed in a shape equal to an arc of a predetermined position on the inner wall circumference of the vessel 53. A lower flange 85 extended from the lower edge 83 is also properly positioned on the inner wall of the vessel 83. An upper edge 84 is extended and enlarged in an arc form facing to the inner wall of the vessel 53 from the lower edge 83 to the upper portion of the vessel 53, and an upper flange 86 is extended from the upper edge 84 to be fixed to the lower surface of the lid 52 or the closing film member 52′ against each other. Therefore, the tea strainer 51 is positioned in the vessel 53 in the form of a basket form. A plurality of tea-straining holes 89 is formed on the tea-straining wall 88 of the tea strainer 51. Therefore, the tea vessel structure 100 permits a user to withdraw tea strained with being separated from the tealeaves loaded in the loader 50 through the plug 80 using a straw or through the withdrawing hole 88.

As shown in FIGS. 14A and 14B with same references being referred to same parts or elements and their detailed explanation being omitted, according to another embodiment similar to the fourth one of the invention, a loader 50 is not provided with a closing film member 52′, but instead of that, an extending portion 90 is extended from a tea-straining wall 88 directly below the tea strainer 51 adjacent to a lid 52 to the inner wall of the vessel 53 except for its wall constituted as the tea strainer 51. The extending portion 90 that is an arc shape corresponding to that of the inner wall of the vessel 53 includes fixing flanges 91 extended from the circumference thereof to be closely contacted to the inner wall of the vessel 53, which is a part of the loader 50. The tea strainer 51 is a vessel of a basket shape on the whole, which includes a tea-straining wall 88 forming a plurality of tea-straining holes in a predetermined arrangement.

Therefore, the tea vessel structure 100 separates tea strained from tealeaves loaded in the tea strainer 51. This permits a user to withdraw tea strained with being separated from the tealeaves loaded in the loader 50 through the plug 80 using a straw or through the withdrawing hole 88.

As shown in FIGS. 15A and 15B with same references being referred to same parts or elements and their detailed explanation being omitted, according to another embodiment similar to the fourth one of the invention, a tea vessel structure 100 comprising a loader 50 provided with a tea strainer 51 being integrally coupled with a cap portion 80 is illustrated.

The loader 50 includes the tea strainer 51 supported on a tea vessel structure lid 52. The lid 52 comprises a cap portion 80 including a cutting portion formed at the center to supply water into the loader 50 and a coupling groove portion 93 formed on an extending portion extended downward in a distance therefrom. A tea-withdrawing hole 82 is formed adjacent to the inner wall of the vessel 53 on the circular circumference of the lid 52. The tea strainer 51 includes a cylindrical body provided with a coupling projection 94 formed around the circumference adjacent to the upper portion thereof to be coupled into the groove portion 93. The tea strainer 51 includes a lower surface 97 forming a plurality of tea-straining holes 98 in a predetermined area adjacent to the center portion thereof. A tea-straining wall 95 is provided with a retaining wall 96 having a certain depth to receive an amount of tealeaves. A plurality of tea-straining holes 99 are formed on around the circumference of the tea-straining wall 95 over the retaining wall 96 to enable the straining of the tealeaves.

Therefore, the tea vessel structure 100 separates tea strained from tealeaves loaded in the tea strainer 51. This permits a user to withdraw tea strained with being separated from the tealeaves through the withdrawing hole 82 formed on the lid 52

Acting Effect.

As described above, according to the invention a tea vessel structure comprises a loader integrally or detachably mounted in a vessel including a disposal cup or all kind forms of cup to receive the tealeaves thereinto. The tea vessel structure permits a green tea and a jasmine tea of various tealeaves to be fully strained out, so that an inherent bitter taste thereof is not remained last after being strained.

What is claimed is:

1. A tea vessel structure comprising a vessel of a disposal cup type or various forms of cup; a lid covering the upper portion of the vessel; and a loader containing a predetermined amount of tealeaves therein to strain out tealeaves by pouring water over tealeaves, in which;
the loader comprises a tea strainer including a tea straining wall forming a plurality of tea-straining holes around the circumference thereof and a bottom surface forming a plurality of tea-straining holes adjacent to the center portion thereof in a predetermined arrangement;
a cover removably mounted to cover the upper surface of the tea strainer with a supporting rod being integrally projected from the upper center portion thereof to cooperate with the lid; and,
a base portion projected from a bottom surface of the tea strainer to keep a predetermined gap between the lower surface of the vessel and the bottom surface of thereof.

2. The tea vessel structure as claimed in claim 1, in which;
a plurality of grooves and projections are formed on the upper portion of the tea strainer and the opening end portion of the lid to be corresponded to each other for the positioning of the cover on the tea strainer.

3. The tea vessel structure as claimed in claim 1, in which;
a plurality of longitudinal slots are radially formed on the tea-straining wall and bottom surface, respectively, instead of circular holes in a certain arrangement.

4. The tea vessel structure as claimed in claim 1, in which;
the base portion formed on the bottom surface is substituted with any one of a leg portion, projection and extending portion.

5. The tea vessel structure as claimed in claim 1, in which;
the loader is supported on a plurality of specers to be positioned in the vessel, in which the spacer includes projections projected from the inner wall of the vessel 3 and semi-circular shape and retangular projections formed on the outer circumference wall of the tea strainer.

6. The tea vessel structure as claimed in claim 1, in which;
the tea strainer is constructed as a single sealing body, on the tea-straining wall of which a plurality of predetermined shaped holes are formed.

7. A tea vessel structure comprising a vessel of a disposal cup type or various forms of cup; a lid covering the upper portion of the vessel; and a loader containing a predetermined amount of tealeaves therein to strain out the tealeaves by pouring water over the tealeaves, in which;
the loader comprises a tea strainer including a tea straining wall forming a plurality of tea-straining holes around the circumference thereof and a bottom surface forming a plurality of tea-straining holes adjacent to the center portion thereof in a predetermined arrangement, a first extending portion integrally extended from around the lower circumference of the bottom surface to be closely contacted to the vessel wall and including a plurality of holes formed adjacent to the vessel wall for withdrawing some tea strained and at least one fixing portion extended from predetermined portions around the circumference of the first extending portion to be closely supported to the vessel wall; and
a cover including an upper surface forming a plurality of holes to inflow water onto the tealeaves loaded there through, a flange extended downward from around the outer circumference of the upper surface to be closely contacted to the upper portion of the tea-straining wall, a second extending portion extended passing the flange from the upper surface with a plurality of second holes formed adjacent to the vessel wall to withdraw some tea strained and at least one second fixing portion extended from predetermined portions around the circumference of the second extending portion to be closely supported to the vessel wall.

8. A tea vessel structure as claimed in claim 7, in which;
the tea vessel structure comprises a loader that is formed as a tea strainer of a basket shape having a wall portion extended facing to an arc portion of a vessel wall from the middle height portion to the upper portion of the vessel wall.

9. The tea vessel structure as claimed in claim 7, in which;
the tea vessel structure comprises a loader including a tea strainer of a basket shape having a wall portion extended facing to an arc portion of a vessel wall from the middle height portion to the upper portion of the vessel wall and flanges expended from the upper and/or lower portions of the tea strainer to position the tea strainer adjacent to the vessel wall.

10. A tea vessel structure comprises a vessel of a disposal cup type or various forms of cup; a lid covering the upper portion of the vessel; and a loader containing a predetermined amount of tealeaves therein to strain out the tealeaves by pouring hot water over the tealeaves, in which;
the loader comprises a cap portion supported on the lid and including cutting portion formed at the center to supply tea water into the loader and a coupling groove portion formed on the lower extending portion thereof; and
a tea strainer including a cylindrical body provided with a coupling projection formed around the circumference adjacent to the upper portion thereof to be coupled into the groove portion, a lower surface forming a plurality of tea-straining holes in a predetermined area adjacent to the center portion thereof and a tea straining wall provided with a retaining wall having a certain depth to receive an amount of tealeaves and forming a plurality of tea-straining holes around the circumference thereof over the retaining wall to enable the straining of the tealeaves.
